(19) United States
(12) Patent Application Publication
(10) Pub. No.: US 2025/0209570 A1
(43) Pub. Date: Jun. 26, 2025

(54) VIDEO OPTIMIZATION PROCESSING SYSTEM AND METHOD RELATED APPLICATIONS

(71) Applicant: KKCOMPANY TECHNOLOGIES PTE. LTD., Singapore (SG)

(72) Inventors: Shuen-Huei GUAN, Taipei City (TW); Feng-Hsu TSAI, Taipei City (TW)

(73) Assignee: KKCOMPANY TECHNOLOGIES PTE. LTD., Singapore (SG)

(21) Appl. No.: 18/936,634

(22) Filed: Nov. 4, 2024

Related U.S. Application Data
(63) Continuation of application No. 16/369,527, filed on Mar. 29, 2019, now abandoned.

(30) Foreign Application Priority Data
Mar. 30, 2018 (TW) 107117366
Dec. 12, 2018 (TW) 107144846

(51) Int. Cl. G06T 5/20; G06T 3/40; G06T 5/50; G06T 5/70; G06T 5/73; G06T 9/00

(52) U.S. Cl. CPC G06T 5/20; G06T 3/40; G06T 5/50; G06T 5/70; G06T 5/73; G06T 9/00; G06T 2207/10016; G06T 2207/20224

(57) ABSTRACT

The present disclosure provides a video optimization processing system that includes a server and a user device. The server compresses a first video to generate a second video and a third video, so as to compare the third video and the second video to generate difference information, and the server calculates, according to the difference information, at least one enhancement parameter and at least one image enhancement algorithm. The user device executes the video playing software and receives the third video, the at least one image enhancement algorithm and the at least one enhancement parameter from the server. The video playing software restores the third video to generate the fourth video based on the at least one image enhancement algorithm and the at least one enhancement parameter, thereby playing the fourth video.

### PATENT APPLICATION

This application is a continuation of Ser. No. 16/369,527, filed Mar. 29, 2019 which claims priority to Taiwan Application Serial Number 107117366, filed Mar. 30, 2018, in view of Taiwan Application Serial Number 107144846, filed Dec. 12, 2018, the entire contents of which are hereby incorporated by reference herein.

### BACKGROUND OF THE INVENTION

### Field of Invention

The present invention relates to a device and a method. More particularly, the present invention relates to a video optimization processing system and method.

### Description of Related Art

Streaming media is a technology to compress a series of media data, and the media data is transmitted by internet in a segmentation manner. Due to such technology, the media data is transmitted by internet in real time for viewers to watch, and such technology make data package transmit like flowing water.

Conventionally, since bandwidth requirement for streaming media data is huge, the media data shall be compressed first and then transmitted through internet. However, the higher compression, the higher distortion of the media data. As such, the video playing quality is worse after the compressed media data is restored.

### SUMMARY OF THE INVENTION

The following presents a simplified summary of the disclosure in order to provide a basic understanding to the reader. This summary is not an extensive overview of the disclosure and it does not identify key/critical elements of the present invention or delineate the scope of the present invention.

One aspect of the present disclosure is directed to a video optimization processing system. The video optimization processing system includes a server and a user device. The server is configured to compress a first video to generate a second video and a third video, so as to compare the third video and the second video to generate a difference information, wherein the server calculates, according to the difference information, at least one image enhancement algorithm and at least one enhancement parameter. The user device is configured to execute a video playing software, and receive the third video, the at least one image enhancement algorithm, and the at least one enhancement parameter, wherein the video playing software, according to the at least one image enhancement algorithm and the at least one enhancement parameter, restores the third video to generate a fourth video, thereby playing the fourth video.

Another aspect of the present disclosure is directed to a video optimization processing method. The video optimization processing method includes steps as follows: compressing a first video, by a server, to generate a second video and a third video, so as to compare the third video and the second video to generate a difference information, and calculating, according to the difference information, at least one image enhancement algorithm and at least one enhancement parameter; and executing, by a user device, a video playing software, and receiving the third video, the at least one image enhancement algorithm, and the at least one enhancement parameter from the server, wherein the video playing software, according to the at least one image enhancement algorithm and the at least one enhancement parameter, restores the third video to generate a fourth video, thereby playing the fourth video.

In view of the above embodiments of the present disclosure, it is apparent that the application of the present invention has the advantages as follows. The embodiment of the present disclosure provides a video optimization processing system and method, which allows high compression video to be transmitted so as to save the bandwidth. Furthermore, after the restored video is compensated, the image quality is near the image quality of the original video.

These and other features, aspects, and advantages of the present invention, as well as the technical means and embodiments employed by the present invention, will become better understood with reference to the following description in connection with the accompanying drawings and appended claims.

### BRIEF DESCRIPTION OF THE DRAWINGS

The invention can be more fully understood by reading the following detailed description of the embodiment, with reference made to the accompanying drawings as follows:

FIG. 1A is a circuit block diagram of a video optimization processing system according to some embodiments of the present disclosure.

FIG. 1B is an operation diagram of video an optimization processing system according to some embodiments of the present disclosure.

FIG. 2 is a flow diagram of a video optimization processing method according to some embodiments of the present disclosure.

In accordance with common practice, the various described features/elements are not drawn to scale but instead are drawn to best illustrate specific features/elements relevant to the present invention. Also, wherever possible, like or the same reference numerals are used in the drawings and the description to refer to the same or like parts.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Unless otherwise defined herein, scientific and technical terminologies employed in the present disclosure shall have the meanings that are commonly understood and used by one of ordinary skill in the art. Unless otherwise required by context, it will be understood that singular terms shall include plural forms of the same and plural terms shall include singular forms of the same.

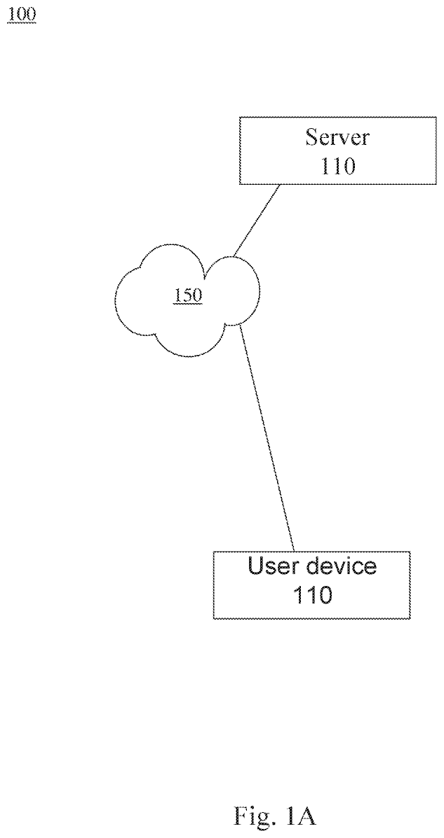

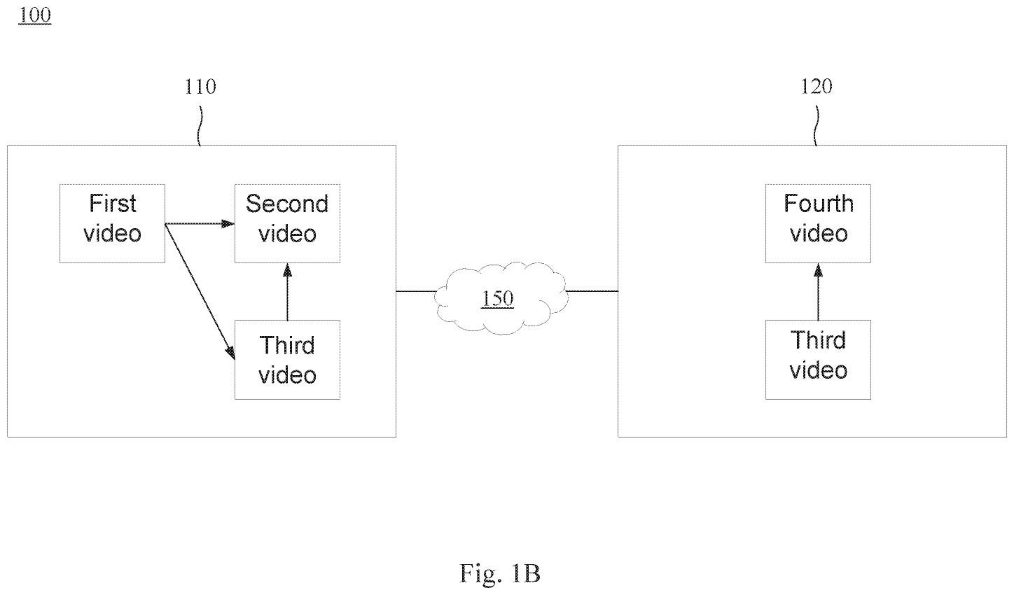

FIG. 1A is a circuit block diagram of a video optimization processing system 100 according to some embodiments of the present disclosure. As shown in FIG. 1A, the video optimization processing system 100 includes a server 110 and a user device 120. With respect to the structure illustrated in FIG. 1A, the server 110 transmits video stream through internet 150 (i.e., internet) and the user device 120 (i.e., mobile devices, personal computers, and so on). As such, the user device 120 may receive video stream from the server 110.

For facilitating the understanding of the operations of the video optimization processing system 100, reference is made to FIG. 1B, which is an operation diagram of the video optimization processing system 100 according to some embodiments of the present disclosure. For saving the transmitting bandwidth, the server 110 compresses a first video (i.e., original video data) for generating a second video and a third video. Specifically, the server 110 compresses the first video in order to generate the second video and the third video according to different resolutions and bit rates. For example, the resolution of the third video (i.e., 720p) is lower than the resolution of the second video (i.e., 1080p).

On the other hand, for assisting the user device 120 to compensate every video in a suitable way, the server 110 further compares the third video and the second video to generate difference information, and the server 110 calculates, according to the difference information, at least one image enhancement algorithm and at least one enhancement parameter.

In one embodiment, the server 110 obtains the at least one image enhancement algorithm and the at least one enhancement parameter by a machine learning means according to difference information. For example, the server 110 compares the third video and the second video, such that the at least one image enhancement algorithm and the at least one enhancement parameter are obtained by the machine learning means. For example, at least one algorithm can be adopted; in some cases, the at least one algorithm includes one or a plurality of algorithms (in the condition that a plurality of algorithms are adopted, AL1, AL2 . . . AL5 are used to represent different algorithms in the following descriptions). By the machine learning means, an image enhanced algorithm and an enhanced parameter, which can enhance the third video such that the third video is near the second video, can be obtained. Each of the above-mentioned algorithms has its own strength, and different enhanced effects can be achieved by using different combination of the algorithms, which is as shown below:
Frame1:AL1(L1)+AL2(L3)+AL3(L2)+AL4(L2)+AL5(L3)
Frame2:AL1(L1)+AL3(L2)+AL4(L1)+AL5(L3)
Frame3:AL3(L2)+AL2(L1)+AL4(L3)+AL5(L3) Frame4:AL2(L3)

As shown above, the above-mentioned video Frame can be the combination of the algorithms which is obtained by the machine learning means. In addition, L1, L2, L3 . . . represent strength. For example, L1 represents a first strength, L2 represents a second strength. Furthermore, AL1(L1) represents an enhanced parameter, AL2(L3) represents another enhanced parameter, and so on. As mentioned above, the video Frame1 includes five enhanced parameters. In one embodiment, the sequence of the strength can be that L1 is the weakest, L2 is the second weakest. Explained in a different way, the bigger the number is, the larger the strength will be. On the other hand, the sequence of the strength can be that L1 is the strongest, L2 is the second strongest. Explained in a different way, the smaller the number is, the larger the strength will be. It is noted that the relation between the number and the strength can be set based on actual requirements. In one embodiment, the at least one image enhancement algorithm can be Deringing algorithm or Deblocking algorithm. However, the present disclosure is not intended to be limited thereto, other suitable algorithms can be adopted based on actual requirements.

If the user wants to watch the stream video, the user device 120 may execute a video playing software, and receive the third video, the at least one image enhancement algorithm, and the at least one enhancement parameter from the server 110. Since the third video is compressed, the data of the third video (i.e., 720p) is lower. In addition, the at least one image enhancement algorithm and the at least one enhancement parameter merely include value data. Therefore, the transmission efficiency is increased.

The video playing software restores the third video for generating a fourth video according to the at least one image enhancement algorithm and the at least one enhancement parameter, thereby playing the fourth video. The resolution of the fourth video and the resolution of the second video are the same. The second video can be obtained by enhancing the third video based on one or a plurality of image enhanced algorithms and one or a plurality of enhancement parameters which are obtained by the machine learning means. As described above, it is not merely using software simulating compensation manner. Therefore, the image quality of the fourth video, which is obtained by restoring the third video based on the image enhanced algorithm and the enhancement parameter, is approximately near the image quality of the second video.

In addition, the server 110 is further configured to enhance the third video according to the at least one image enhancement algorithm and the at least one enhancement parameter, and a smoothing process is executed to the enhanced third video to generate an image compensation information. For example, since it is known that the video has to be enhanced into the second video (i.e., 1080p), the present disclosure can find one or a plurality of image enhanced algorithms and one or a plurality of enhancement parameters by the machine learning means so as to make the enhanced third video approach the second video. At the same time, for the enhanced third video approaching the second video more, the smoothing process is executed to the third video so as to obtain the image compensation information. Subsequently, the loss of the enhanced third video can be compensated based on the image compensation information to make the enhanced third video approach the second video more.

As such, if the user device 120 receives the image compensation information from the server 110 and the video playing software restores the third video according to the image compensation information, the at least one image enhancement algorithm and the at least one enhancement parameter so as to generate the fourth video at the same time, the fourth video is approximately near the second video, thereby enhancing the video play effect.

In addition, before the smoothing process is executed, the server 110 of the present disclosure can further execute a high pass filter process to the third video. As such, part of the video which contains more detail will be remained, and part of the video which contains less detail will be filtered. Subsequently, the smoothing process is executed, and the image compensation information which contains more details can be obtained. For example, the image compensation information can be obtained by the following formula:

smooth(high-pass filter(a−Eb)) formula 1

As shown in formula 1, a represents the second video, and Eb represents the enhanced third video. After a difference information between the second video and the enhanced third video is obtained, a high pass filter process is executed to the difference information. Subsequently, the smoothing process is executed to obtain the image compensation information. Similarly, the user device 120 receives the image compensation information from the server 110, and the video playing software restores the third video according to the image compensation information, the at least one image enhancement algorithm, and the at least one enhancement parameter so as to generate the fourth video, such that the fourth video is approximately near the second video, thereby enhancing the video play effect.

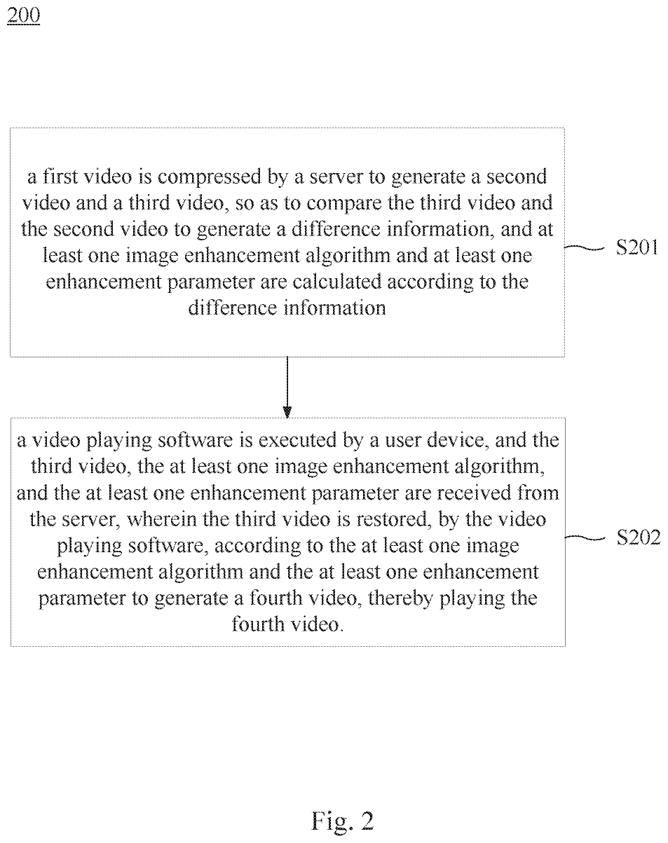

For facilitating the operation method of the video optimization processing system, please refer to FIGS. 1A, 1B, and 2. FIG. 2 is a flow diagram of a video optimization processing method 200 according to some embodiments of the present disclosure. As illustrated in Fig, 2, the video optimization processing method 200 includes steps S201 s202 (it is noted that unless sequence of steps as described in the embodiment is specific limited, other sequence of steps can also be set according to actual requirements. In addition, all of the steps can be executed at the same time, or part of the steps can be executed at the same time).

In step S201, a first video is compressed by the server 110 to generate a second video and a third video, so as to compare the third video and the second video to generate a difference information, and at least one image enhancement algorithm and at least one enhancement parameter are calculated according to the difference information.

In step S202, a video playing software is executed by the user device 120, and the third video, the at least one image enhancement algorithm, and the at least one enhancement parameter are received from the server 110, wherein the third video is restored, by the video playing software, according to the at least one image enhancement algorithm and the at least one enhancement parameter to generate a fourth video, thereby playing the fourth video.

In the video optimization processing method 200, the third video is enhanced, by the server 110, according to the at least one image enhancement algorithm and the at least one enhancement parameter, and a smoothing process is executed to the enhanced third video to generate image compensation information.

In the video optimization processing method 200, the third video is restored according to the image compensation information, the at least one image enhancement algorithm, and the at least one enhancement parameter by the video playing software so as to generate the fourth video.

In the video optimization processing method 200, after a high pass filter process is executed to the enhanced third video by the server 110, a smoothing process is executed to the enhanced third video to generate image compensation information.

In the video optimization processing method 200, the resolution of the third video is lower than the resolution of the second video.

In the video optimization processing method 200, the resolution of the second video and the resolution of the fourth video are the same.

In view of the above embodiments of the present disclosure, it is apparent that the application of the present invention has the advantages as follows. The embodiment of the present disclosure provides a video optimization processing system and method, which allows high compression video to be transmitted so as to save the bandwidth. Furthermore, after the restored video is compensated, the image quality is near the image quality of the original video.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

1. A video optimization processing system, comprising:
a server configured to:
compress a first video to generate a second video and a third video;
compare the third video and the second video to generate a difference information;
calculate, according to the difference information, at least one image enhancement algorithm and at least one enhancement parameter;
transmit, to a user device, the third video, the at least one image enhancement algorithm, and the at least one enhancement parameter; and
the user device configured to:
receive the third video, the at least one image enhancement algorithm, and the at least one enhancement parameter; and
that utilizes the at least one image enhancement algorithm and the at least one enhancement parameter to restore the third video to generate a fourth video, thereby playing the fourth video.

2. The video optimization processing system of claim 1, wherein the server is further configured to enhance the third video according to the at least one image enhancement algorithm and the at least one enhancement parameter, and execute a smoothing process to the third video which is enhanced so as to generate an image compensation information.

3. The video optimization processing system of claim 2, wherein the video playing software further restores the third video according to the image compensation information, the at least one image enhancement algorithm, and the at least one enhancement parameter so as to generate the fourth video.

4. The video optimization processing system of claim 3, wherein the server executes a high pass filter process to the third video which is enhanced, and then executes a smoothing process to the third video which is enhanced so as to generate the image compensation information.

5. The video optimization processing system of claim 1, wherein a resolution of the third video is lower than a resolution of the second video.

6. The video optimization processing system of claim 5, wherein a resolution of the second video and a resolution of the fourth video are the same.

7. A video optimization processing method, comprising:
compressing a first video, by a server, to generate a second video and a third video, so as to compare the third video and the second video to generate a difference information, and calculating, according to the difference information, at least one image enhancement algorithm and at least one enhancement parameter; and
executing, by a user device, a video playing software, and receiving the third video, the at least one image enhancement algorithm, and the at least one enhancement parameter from the server, wherein the video playing software, according to the at least one image enhancement algorithm and the at least one enhancement parameter, restores the third video to generate a fourth video, thereby playing the fourth video.

8. The video optimization processing method of claim 7, wherein the third video is enhanced by the server according to the at least one image enhancement algorithm and the at least one enhancement parameter, and a smoothing process is executed to the third video which is enhanced so as to generate an image compensation information.

9. The video optimization processing method of claim 8, wherein the video playing software further restores the third video according to the image compensation information, the at least one image enhancement algorithm, and the at least one enhancement parameter so as to generate the fourth video.

10. The video optimization processing method of claim 9, wherein a high pass filter process is executed, by the server, to the third video which is enhanced, and then a smoothing process is executed to the third video which is enhanced so as to generate the image compensation information.

11. The video optimization processing method of claim 7, wherein a resolution of the third video is lower than a resolution of the second video.

12. The video optimization processing method of claim 7, wherein a resolution of the second video and a resolution of the fourth video are the same.
